(19) United States
(12) Patent Application Publication
(10) Pub. No.: US 2015/0381381 A1
(43) Pub. Date: Dec. 31, 2015

(54) METHODS AND SYSTEMS FOR TRANSMITTING GROUP DATA USING A DOWNLINK GROUP DATA CHANNEL

(71) Applicant: MOTOROLA SOLUTIONS, INC, Schaumburg, IL (US)

(72) Inventor: DEAN S. DYSON, BASINGSTOKE (GB)

(21) Appl. No.: 14/318,860

(22) Filed: Jun. 30, 2014

(51) Int. Cl. H04L 12/18; H04H 20/72; H04W 24/08; H04W 4/14

(52) U.S. Cl. CPC H04L 12/1868; H04W 4/14; H04H 20/72; H04W 24/08

(57) ABSTRACT

Disclosed herein are methods and systems for transmitting group data using a downlink group data channel. An embodiment takes the form of a process that includes obtaining data-file segments that collectively make up a data file, and broadcasting the data-file segments on a downlink of a group data channel. The process further includes broadcasting retransmission-partition notices of broadcasted data-file segments. Each notice associates subsets of the broadcasted data-file segments with respective uplink time periods. The process also includes monitoring the associated uplink time periods for retransmission requests, and rebroadcasting the data-file segments of the subsets that correspond to any monitored time periods during which at least one retransmission request was received.

### BACKGROUND OF THE INVENTION

Millions of people around the world make daily use of various computing and communication devices. Many of these devices can be accurately characterized as being wireless-communication devices (WCDs), in that they are equipped and configured such that they are able to engage in wireless forms of communication directly with one another and/or via various wireless networks. Examples of commonly used WCDs include cell phones, smartphones, tablets, notebook computers, laptop computers, and the like. The wireless networks via which these WCDs engage in wireless communication typically operate according to one or more relatively long-range wireless-communication protocols (e.g., Global System for Mobile Communications (GSM), Long Term Evolution (LTE), and the like), one or more relatively short-range wireless-communication protocols (e.g., Wi-Fi and the like), and/or one or more land mobile radio (LMR) protocols (e.g., European Telecommunications Standards Institute Digital Mobile Radio (ETSI-DMR), Terrestrial Trunked Radio (TETRA), APCO Project 25 (P25), Digital Mobile Radio (DMR), and the like), among numerous other examples.

One context in which fast and reliable wireless communication is especially important is the public-safety context. An effective public-safety network should facilitate not only voice communication but also data communication. For example with respect to data communication, public-safety responders may advantageously be provided with digital files representing photographs of suspects, maps of buildings, digital dossiers, and the like. The network should also provide for communication among WCDs from numerous public-safety responders from multiple disciplines (e.g., police, fire, EMS) and from multiple jurisdictions (e.g., city fire, state police, county sheriff, etc.). The communication should make efficient use of limited air-interface resources. Accordingly, there is a need for improved methods and systems for transmitting group data using a downlink group data channel.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example communication system, in accordance with various embodiments.

FIG. 2 depicts an example radio access network (RAN) via which one or more WCDs can communicate, in accordance with various embodiments.

FIG. 3 depicts an example base station, in accordance with various embodiments.

FIG. 4 is a flowchart of an example process, in accordance with various embodiments.

FIGS. 5, 6, and 7 depict aspects of an example data file, in accordance with various embodiments.

FIGS. 8-10 depict various aspects of example retransmission-partition notices and of example subsets of data-file segments identified by the respective example notices, in accordance with various embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed herein are methods and systems for transmitting group data using a downlink group data channel. An embodiment takes the form of a process that includes obtaining data-file segments that collectively make up a data file, and broadcasting the data-file segments on a downlink of a group data channel. The process further includes broadcasting retransmission-partition notices of broadcasted data-file segments. Each notice associates subsets of the broadcasted data-file segments with respective uplink time periods. The process also includes monitoring the associated uplink time periods for retransmission requests, and rebroadcasting the data-file segments of the subsets that correspond to any monitored time periods during which at least one retransmission request was received.

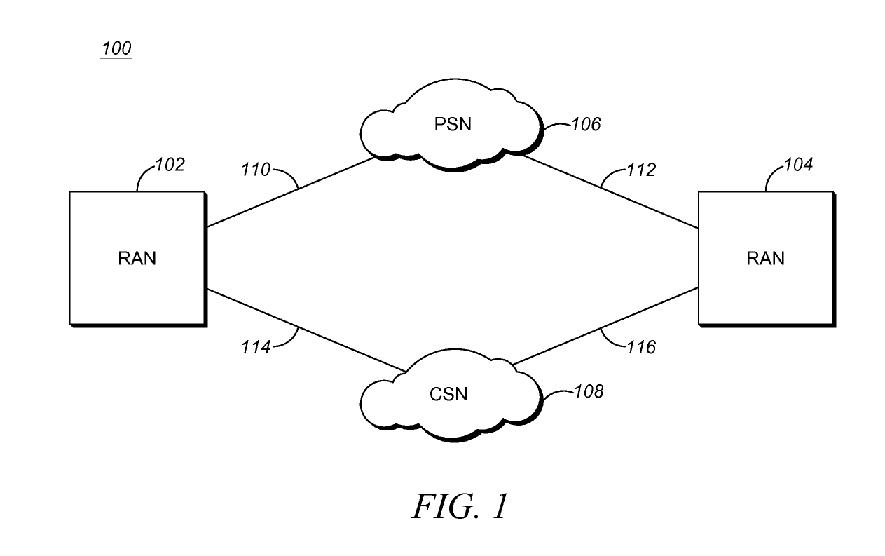

FIG. 1 depicts an example communication system, in accordance with various embodiments. As shown, communication system 100 includes respective RANs 102 and 104, a packet-switched network (PSN) 106, and a circuit-switched network (CSN) 108. Networks 102 and 104 are connected to PSN 106 by respective communication links 110 and 112, and to CSN 108 by respective communication links 114 and 116. Those having skill in the art will appreciate that additional and/or different entities may be present in communication system 100. For example, in accordance with some embodiments, the communication system 100 includes only a single RAN.

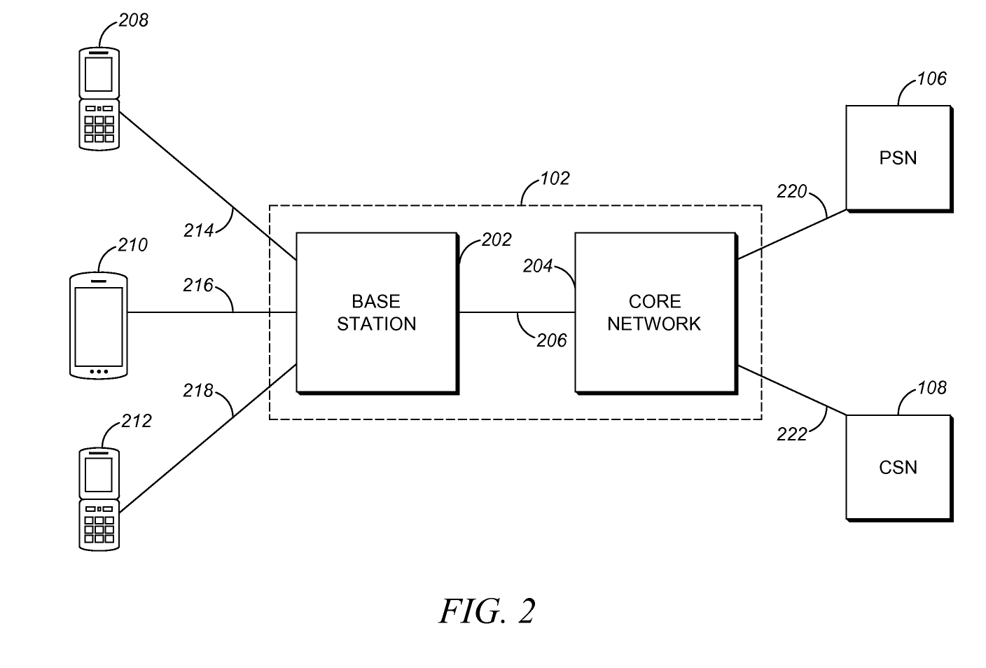

RAN 102 is discussed in further detail below with reference to FIG. 2, though in general, RANs 102 and 104 may be any networks equipped and configured by those of skill in the relevant art to function as described herein. One or both of RANs 102 and 104 may operate according to one or more communication protocols such as TErrestrial Trunked RAdio (TETRA), LTE, Global System for Mobile Communications (GSM), CDMA2000, IEEE 802.11 (Wi-Fi), Bluetooth, ZigBee, and/or any other network protocol or standard, among many other possibilities known to those of skill in the relevant art.

In an embodiment, RAN 102 and/or RAN 104 is a public-safety network. In such an embodiment, the RAN is equipped, configured, and programmed to provide one or more public-safety agencies with wireless access to one or more networks, to facilitate provision of the communication and computing needs of those one or more public-safety agencies. The RAN may include or be connected to a dispatch center that itself may be communicatively connected with PSN 106 and/or CSN 108, for retrieving and transmitting any necessary public-safety-related data and/or communications.

PSN 106 could be the worldwide network typically referred to as the Internet, but could just as well be any other packet-switched network equipped and configured by those of skill in the relevant art to function as described herein. Entities resident on PSN 106 may be Internet Protocol (IP) entities and may be addressed using IP addresses, as examples. CSN 108 could be the circuit-switched communication network typically referred to as the Public Switched Telephone Network (PSTN), but could just as well be any other circuit-switched network arranged and configured by those of skill in the relevant art to function as described herein.

Any one or more of communication links 110-116 could include one or more communication devices, networks, connections, switches, bridges, routers, and the like. Any or all of communication links 110-116 could make use of wired and/or wireless forms of communication. Moreover, one or more communication links instead of and/or in addition to communication links 110-116 could be present. As one example, there could be one or more communication links between PSN 106 and CSN 108.

FIG. 2 depicts an example RAN via which one or more WCDs can communicate, in accordance with various embodiments. As shown in FIG. 2, RAN 102 includes a base station 202 and a core network 204 that are communicatively connected via a communication link 206. Base station 202 is communicatively connected to WCDs 208, 210, and 212 via respective air-interface links 214, 216, and 218, and core network 204 is communicatively connected to PSN 106 and CSN 108 via respective communication links 220 and 222. RAN 104 could take a form identical or similar to RAN 102.

Base station 202 may be any network-side entity that is suitably equipped and configured by those of skill in the relevant art to function as described herein, which in general is to provide wireless service to WCDs (such as WCDs 208, 210, and 212) over respective air-interface links (such as respective air-interface links 214, 216, and 218). Base station 202 could take the form of a TETRA base station, a Wi-Fi access point, a GSM/CDMA200 base transceiver station (BTS), and/or an LTE eNodeB, among numerous other examples known to those of skill in the relevant art. Moreover, while one base station 202 and three WCDs 208, 210, and 212 are depicted in FIG. 2, this is by way of illustration and not by way of limitation, as any number of either could be present in a given implementation.

Air-interface links 214, 216, and 218 may each include a respective downlink and a respective uplink, or may form a shared uplink and downlink. Any one or more of the individual or shared downlinks and/or uplinks may take the form of respective air-interface channels and could be modulated using Time Division Multiple Access (TDMA), Frequency Division Multiple Access (FDMA), and/or Quadrature Phase-Shift Keying (QPSK), among numerous other examples known to those of skill in the relevant art. In the time domain, a given channel may divided into frames, time slots, sub slots, etc. A respective downlink channel could (though need not) take the form of a shared channel, and could provide one or more of a circuit-mode-data service, a packet-mode-data service, and/or a Short Data Service (SDS) (i.e., a Short Message Service (SMS)), among numerous other examples known to those of skill in the relevant art. Communication over a given channel may be addressed to a single WCD using an identifier uniquely associated with that single WCD (e.g., an Individual Short Subscriber Identity (ISSI)) and/or to multiple WCDs using an identifier that is associated with those multiple WCDs as a group (e.g., a Group Short Subscriber Identity (GSSI)).

Core network 204 may include one or more network entities such as one or more mobility management entities (MMEs), one or more serving gateways (SGWs), one or more packet data network (PDN) gateways (PGWs), one or more evolved packet data gateways (ePDGs), one or more home subscriber servers (HSSs), one or more access network discovery and selection functions (ANDSFs), and/or one or more other entities deemed suitable for a given implementation by those of skill in the relevant art. Moreover, these entities may be configured and interconnected in a manner known to those of skill in the relevant art to provide wireless service to the WCDs 208, 210, and 212 via base station 202, and to bridge such wireless service with various transport networks. These examples are provided for illustration and not by way of limitation; moreover, those of skill in the relevant art are aware of variations among different protocols and among different implementations of a given protocol, and of similarities across different protocols.

Communication links 206, 220, and 222 may take any suitable form, such as any of the forms described above in connection with links 110-116 of FIG. 1. Communication link 206 may function as what is known as a “backhaul” with respect to base station 202, as link 206 may enable core network 204 to bridge (i) communications conducted by base station 202 with WCDs over respective air interfaces with (ii) communications via the rest of RAN 102 and beyond. One or more entities such as one or more network access servers (NASs) and/or Voice over IP (VoIP) gateways may reside on any one or more of the communication links to bridge RAN 102 to one or more other networks.

WCDs 208, 210, and 212 may take the form of respective mobile phones, smart phones, tablet computers, notebook computers, desktop computers, and/or any other types of wireless-communication devices suitably equipped and configured by those of skill in the relevant art to function as described herein.

As known to those of skill in the relevant art, RAN 102 may include additional and/or different entities deemed suitable to a given implementation by those of skill in the relevant art. Moreover, these entities may be configured and interconnected in any manner known to those of skill in the relevant art to provide wireless service to WCDs via base stations, and to bridge such wireless service with transport networks such as PSN 106 and CSN 108. In general, other configurations are possible, as those described herein are provided by way of example and not limitation.

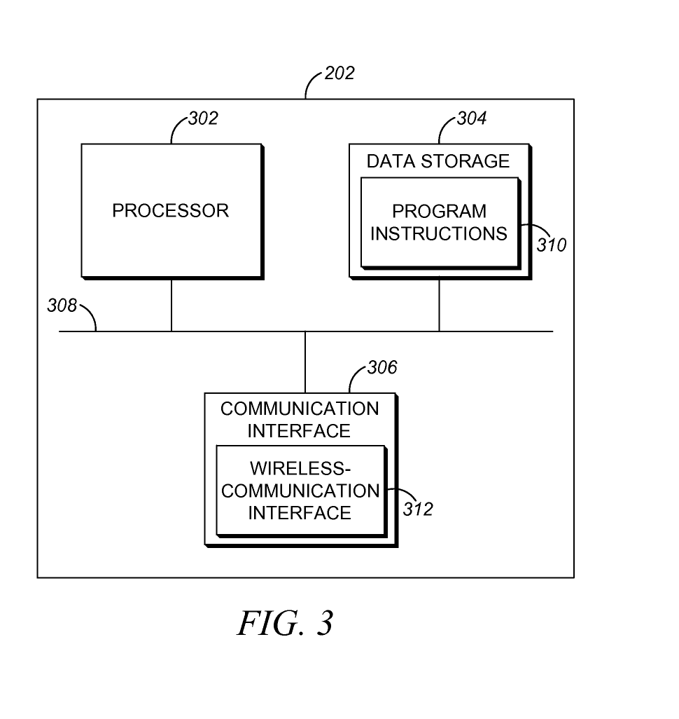

FIG. 3 depicts an example base station, in accordance with various embodiments. As illustrated, base station 202 includes a processor 302, data storage 304, and a communication interface 306, all of which are communicatively connected by a system bus 308 (or other suitable communication network, connection, and/or the like). Different and/or additional components may be present: for example, base station 202 could further include a Global Positioning System (GPS) receiver (among other possibilities). It should be understood that base station 202 may take other forms as well.

Processor 302 may include one or more processors of any type deemed suitable by those of skill in the relevant art, some examples including a general-purpose microprocessor, a dedicated digital signal processor (DSP), and a graphics processor.

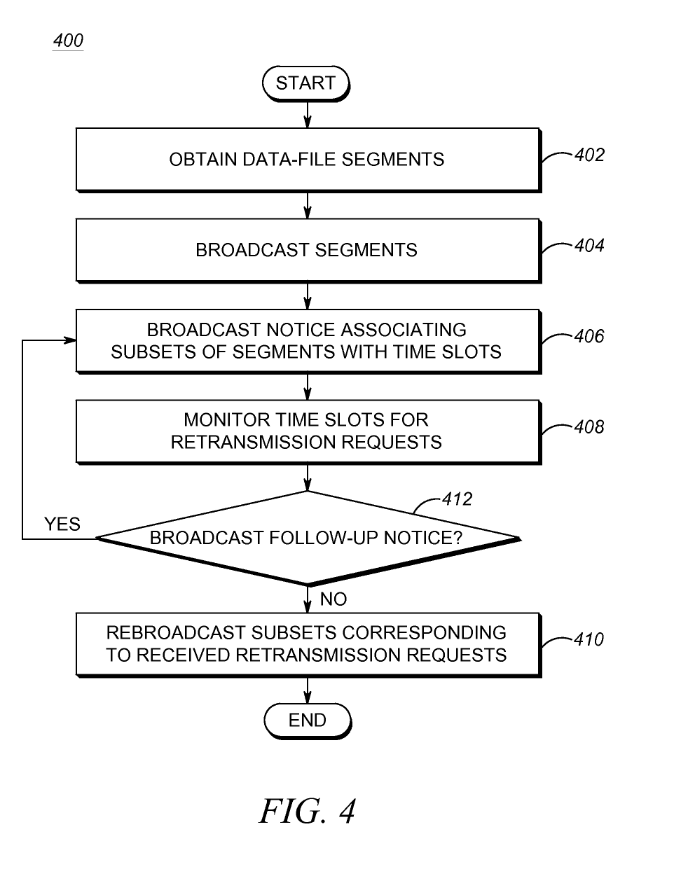

Data storage 304 may take the form of any non-transitory computer-readable medium or combination of such media, some examples including flash memory, read-only memory (ROM), and random-access memory (RAM) to name but a few, as any one or more types of non-transitory data-storage technology deemed suitable by those of skill in the relevant art could be used. In the embodiment that is depicted in FIG. 3, data storage 304 contains program instructions 310 executable by processor 302 for carrying out various combinations of the various functions described herein, such as one or more of those steps set forth in FIG. 4. The data storage could include additional data as well, including (for example) data files, data-file segments, network routing data, and/or any other types of data deemed suitable by those of skill in the relevant art for carrying out the functions described herein.

Communication interface 306 is depicted as including a wireless-communication interface 312, which in turn could include components such as one or more antennae, one or more transmitters and/or receivers designed and configured for one or more types of wireless communication, and/or any other components deemed suitable by those of skill in the relevant art. In addition to wireless-communication interface 312, communication interface 306 could further include additional communication-interface technology such as one or more wired (e.g., Ethernet) communication interfaces for facilitating communication with various network entities.

FIG. 4 is a flowchart of an example process, in accordance with various embodiments. As shown, the process 400 begins at step 402 with a base station obtaining data-file segments that collectively make up a data file. At step 404, the base station broadcasts the data-file segments on a downlink of a group data channel, and at step 406, broadcasts retransmission-partition notices of broadcasted data-file segments. Each retransmission-partition notice associates subsets of the broadcasted data-file segments with respective uplink time periods. At step 408, the base station monitors the associated uplink time periods for retransmission requests, and at step 410, rebroadcasts the data-file segments of the subsets that correspond to any monitored time periods during which at least one retransmission request was received. After broadcasting a given retransmission-partition notice but before rebroadcasting the data-file segments, base station 300 may determine at step 412 whether to broadcast a follow-up retransmission-partition notice.

The following example illustrates an operation of process 400 in the context of delivering a data file to WCDs 208-212 that are communicatively connected to public-safety network 102. At step 402, base station 202 receives, from core network 204, one thousand data-file segments that collectively make up a data file that is a photo of a criminal suspect. The data-file segments have respective segment identifiers ranging from 1601 to 2600, inclusive. Base station 202 broadcasts, to WCDs 208-212, a notification that identifies (i) the data file (e.g., the file name, file type, etc.), (ii) the identifiers of the data-file segments (e.g., 1601 to 2600) that collectively make up the data file, and (iii) a group-data channel on which the data-file segments will be broadcast. At step 404, base station 202 broadcasts data-file segments 1601-1900 on the group-data channel (each data-file segment being broadcast during a respective network-standard time slot in this example), and WCDs 208-212, in order to obtain the data file, tune to the given group-data channel (if not already tuned to that channel) and store any broadcasted data-file segments that have segment identifiers within the range of 1601-2600, inclusive.

At step 406, base station 202 offers to rebroadcast data-file segments 1601-1800 by broadcasting an initial retransmission-partition notice during time slot t=0. The initial retransmission-partition notice associates data-file segments 1601-1700 with time slot t=1 and segments 1701-1800 with time slot t=2. At step 408, base station 212 monitors the associated uplink time slots for retransmission requests.

WCD 208, which did not receive data-file segment 1652, receives the initial retransmission-partition notice and responsively broadcasts a retransmission request during time slot t=1. The retransmission request could (though need not) identify WCD 208 as the requesting WCD and/or data-file segment 1652 as the requested data-file segment. WCD 212 did not receive data-file segment 1683; the WCD thus also broadcasts a retransmission request during time slot t=1 in response to receiving the initial retransmission-partition notice. WCD 210, having received all of data-file segments 1601-1700, does not broadcast any retransmission requests during time slot t=1. Additionally, because each of WCDs 208-212 received all of data-file segments 1701-1800, none of these WCDs broadcast any retransmission requests during time slot t=2.

As stated above, at step 408, base station 202 monitors uplink time slots t=1 and t=2 associated with subsets of data-file segments 1601-1700 and 1701-1800, respectively. During time slot t=1, base station 202 detects a received signal energy that is consistent with one or more retransmission requests.

In this example, because both WCDs 208 and 212 were broadcasting retransmission requests during time slot t=1, the retransmission requests collided, making any decoding of the respective retransmission requests difficult or impossible. However, base station 202 need not determine the identities of any requesting WCDs or requested data-file segments specified in the retransmission requests because (i) the identities of the requested data-file segments are determined by the time slots during which the retransmission requests were broadcast and (ii) the identities of the WCDs requesting retransmission are irrelevant given that any rebroadcasted data-file segments are rebroadcast to all of the WCDs that are communicatively connected to base station 202. Accordingly, the base station need only determine that the energy level of a signal received during a given monitored uplink time slot exceeds a given threshold (this indicating that at least one WCD was likely broadcasting a retransmission request during the given uplink time slot).

Accordingly, having determined that the level of signal energy received during time slot t=1 exceeds an uplink-request threshold, base station 202 determines at step 412 whether to broadcast one or more follow-up retransmission-partition notices. A given base station may make this determination based on, for example, (i) the amount of time required to rebroadcast all of data-file segments corresponding to a given uplink time slot and (ii) the amount of time by which any eventual rebroadcast of the requested data-file segments would be delayed by broadcasting the follow-up retransmission notices (among other possible factors).

Indeed, in various different embodiments, one or more factors among numerous possible factors are considered by the base station 202 at step 412 in making a determination as to whether to broadcast one or more follow-up retransmission-partition notices (or rather instead to rebroadcast all of the data-file segments that correspond to uplink time periods in which at least one retransmission request was received). And moreover, in some implementations, a given factor being in a given state (e.g., air-interface conditions being poor) could tend towards a decision to send out one or more additional notices (i.e., to “drill down” further in an effort to gain more granular information as to which segment(s) actually need(s) to be rebroadcasted) while, in other implementations, that same factor being in that same given state could tend towards a decision to drill down no further, and instead to rebroadcast a likely over-inclusive set of data-file segments. These are choices for those of skill in the art to make in the context of various different implementations.

Some example factors, one or more of which could be considered in the context of a given implementation, include air-interface conditions, number of WCDs to which rebroadcasts would be sent, number of data-file segments total in a given file, number of data-file segments already broadcast, number of data-file segments yet to be (initially broadcast), size of data file as a whole, size of each data-file segment, amount of data represented by data-file segments yet to be broadcast, number of data-file segments that would need to be rebroadcast if no further notices were sent (i.e., if no further “drilling down” were conducted, amount of data represented by that set of data-file segments, and/or one or more other similar factors deemed suitable by those of skill in the relevant art for a given implementation or in a given context. And again, some designers may consider a certain factor being high (or low) to make further notices advisable, while other designers may consider that same factor being in that same state to make it advisable to conduct an immediate rebroadcast (i.e., with no further “drilling down” notices) of a likely overinclusive set of data-file segments.

In this example, a follow-up retransmission-partition notice could identify two subsets of data-file segments selected from segments 1601-1700—e.g., a subset that includes segments 1601-1650 and a subset that includes segments 1651-1700—and could associate each subset with time slots t=5 and t=6, respectively. Since the amount of time required to rebroadcast all of data-file segments 1601-1700 (one hundred time slots) is significantly greater than the delay resulting from broadcasting a follow-up retransmission-partition notice (one time slot for broadcasting the notice and two time slots for monitoring the associated uplink slots), base station 202 determines to broadcast the follow-up retransmission-partition notice.

At step 408, base station 202 monitors uplink time slots t=5 and t=6 associated with subsets of data-file segments 1601-1650 and 1651-1700, respectively. WCDs 208 and 212, in need of data-file segments 1652 and 1683, respectively, both broadcast a retransmission request during time slot t=6, and base station 202 determines that the level of signal energy received during time slot t=6 exceeds the uplink-request threshold. After broadcasting the follow-up retransmission-partition notice and monitoring the associated uplink-request time slots, base station 202 determines at step 412 to not broadcast another follow-up retransmission-partition notice (though it certainly could), and instead rebroadcasts data-file segments 1651-1700.

The above-described example operation of process 400 is discussed in the context of public safety, those of skill in the art will appreciate, however, that process 400 may be employed in various other contexts as well. Further, operation of process 400 is not limited to the example described above, as many embodiments of process 400 exist, as is further discussed below.

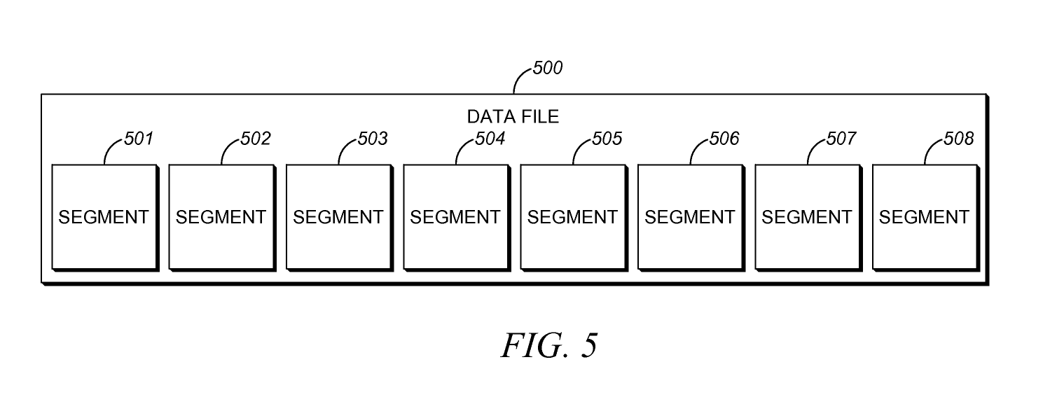

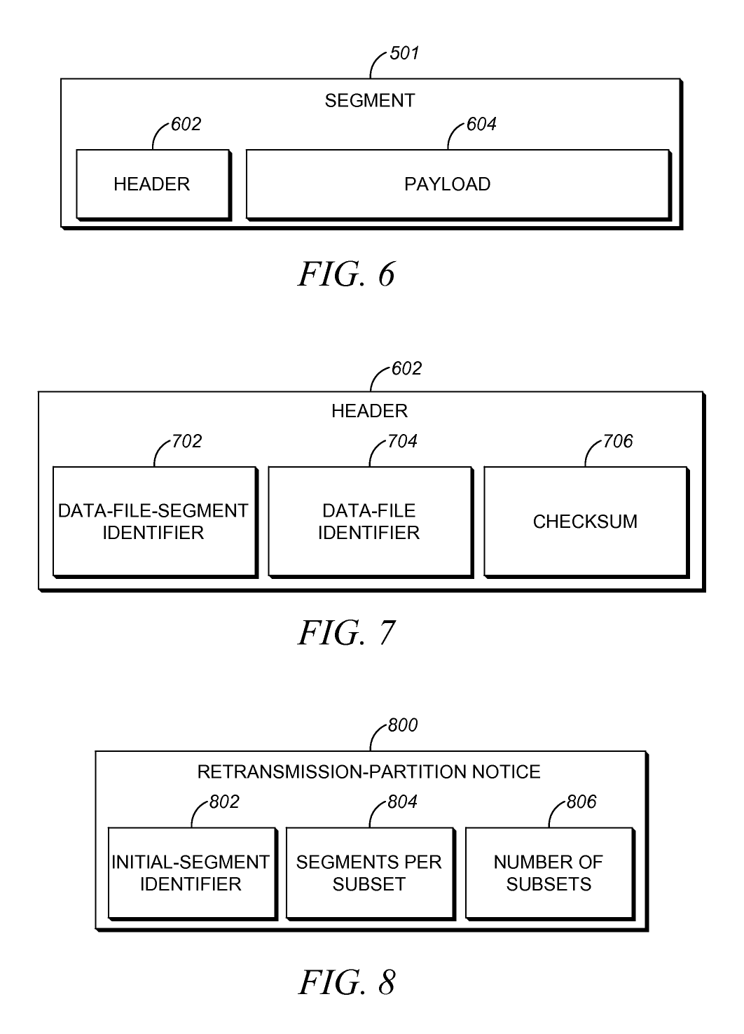

FIGS. 5, 6, and 7 depict aspects of an example data file, in accordance with various embodiments. As shown in FIG. 5, data file 500 includes several data-file segments 501-508, though a given data file may include more or fewer segments. As illustrated in FIG. 6, data-file segment 501 includes a header 602 and a payload 604. The header 602 may contain, e.g., metadata for identifying respective data-file segments and/or facilitating transfer of respective data-file segments between network entities, and the payload 604 may include a part of a respective data file, among other possible variations. As depicted in FIG. 7, header 602 includes a data-file-segment identifier 702, a data-file identifier 704, and a checksum 706. Data file 500 could take various forms, including (but not limited to) an image file, a video file, an audio file, and/or a document file (such as a text file), among other possibilities. Data file 500, data-file segment 501, and/or header 602 could include additional and/or different data as well.

Data-file-segment identifier 702 may take the form of (or include) a sequence identifier that sequentially identifies the data-file segment 501 with respect to the other segments (e.g., segments 502-508) of data file 500. The sequence identifiers of the sequential segments could take the form of sequential integers starting from zero (e.g., 0 to 7) or another number (e.g., 501-508), sequential letters starting from A (e.g., A to H) or another letter, and/or any other sequential identifiers, among numerous other possibilities. In some embodiments, data-file segment 501 is sent using a short messaging service such as SDS, SMS, or the like. In an example in which SDS is used, data-file segment 501 takes the form of an SDS message and data-file-segment identifier 702 takes the form of an SDS-message address field. Data-file-segment identifier 702 could take other forms as well.

It should be noted that, throughout the detailed description, respective data-file segments may be referred to as being “less than” or “greater than” other data-file segments. These references (and other references using similar language) should be understood to mean that the data-file-segment identifier of a given data-file segment is less than or greater than the respective data-file-segment identifiers of other data-file segments.

Data-file identifier 704 may include data-file identifiers that identify the data file of which the respective segments are part. The identifiers could take the form of (or include) file names (e.g., “suspect.jpg” or “dossier.pdf”), or possibly arbitrary strings of numbers and letters that uniquely identify the file during broadcast and/or rebroadcast, among other possibilities. In some embodiments, all of the data-file segments of the data file comprise the same data-file identifier. In some embodiments, a respective data-file identifier takes the form of a data-file-segment identifier (such as a sequence identifier). For example, if a base station indicates a range of sequence identifiers of data-file segments that collectively make up a given data file (indicated perhaps via an SDS message prior to broadcasting the data-file segments), then the sequence identifiers would indicate the data file of which the respective segments are part. Those of skill in the art will appreciate that data-file identifier 704 may take other forms.

Checksum 706 may take the form of (or be based on) a result of a checksum function. The result of the checksum function could be based on other data in header 602 and/or based on payload 604, among other possibilities. The checksum function could take the form of (or include) a cyclic redundancy check (CRC) algorithm, and/or a cryptographic hash function such as MD5, SHA-2, and/or SHA-3, among numerous other possibilities.

With respect to step 402, obtaining the data-file segments may involve base station 202 receiving data file 500, and/or any one or more of data-file segments 501-508, from another network entity known to those of skill in the art such as another base station, gateway, router, and the like. In an embodiment, data-file segments are obtained by segmenting the data file into the obtained data-file segments. For example, base station 202 may receive data file 500 from core network 204 in RAN 102, and may obtain data-file segments 501-508 by segmenting the data file. Those of skill in the art will appreciate that other variations are possible as well.

In an embodiment, base station 202 obtains the data-file segments by receiving the data-file segments from a network entity (such as core network 204). The data-file segments received by base station 202 may be the same data-file segments received by one or more other base stations in RAN 102, which may (re)broadcast the data-file segments in a manner similar to that in which the segments are (re)broadcast by base station 202. Accordingly, base station 202 may broadcast (and rebroadcast) data-file segments of a given data file to WCDs that received one or more segments of the data file from a different base station in RAN 202, facilitating the mobility of the WCDs throughout the network by virtue of network-standard segmentation of files and numbering of corresponding segments.

Regarding step 404, broadcasting a given data-file segment could include addressing the data-file segment using its associated sequence identifier. For example, the data-file segments could be broadcast as SDS messages. An address field of the SDS message could include a segment identifier of a respective data-file segment (instead of or in addition to a GSSI or an ISSI), and a payload of the SDS message could include a respective portion of the data file. In some embodiments, the address field includes both the segment identifier and the data-file identifier. A given WCD receiving a respective data file may filter (e.g., silently discard) any received SDS messages except for those that are part of that data file.

The base station may broadcast segment-transmission notices for indicating to WCDs that the base station is (or soon will be) broadcasting one or more data-file segments. The segment-transmission notice could be broadcast on a control channel (perhaps as an SDS message) and could specify the segment identifier of the first segment of a data file, a number of segments of the data file that are to be broadcast, and a group data channel on which the data-file segments will be broadcast. A given WCD may tune to the group data channel specified in the segment-transmission notice in order to receive the data-file segments. The segment-transmission notice could be broadcast on one or more other channels (instead of or in addition to the control channel) and could include different and/or additional data.

The base station could periodically broadcast the segment-transmission notices, for example, until a given number (e.g., all) of the data-file segments have been broadcast at least once, among other possibilities. Broadcasting subsequent segment-transmission notices may allow WCDs that did not receive the initial notice (e.g., if the WCD was not in range of the base station at the time) to nevertheless receive the data file associated with the data-file segments indicated in the notification.

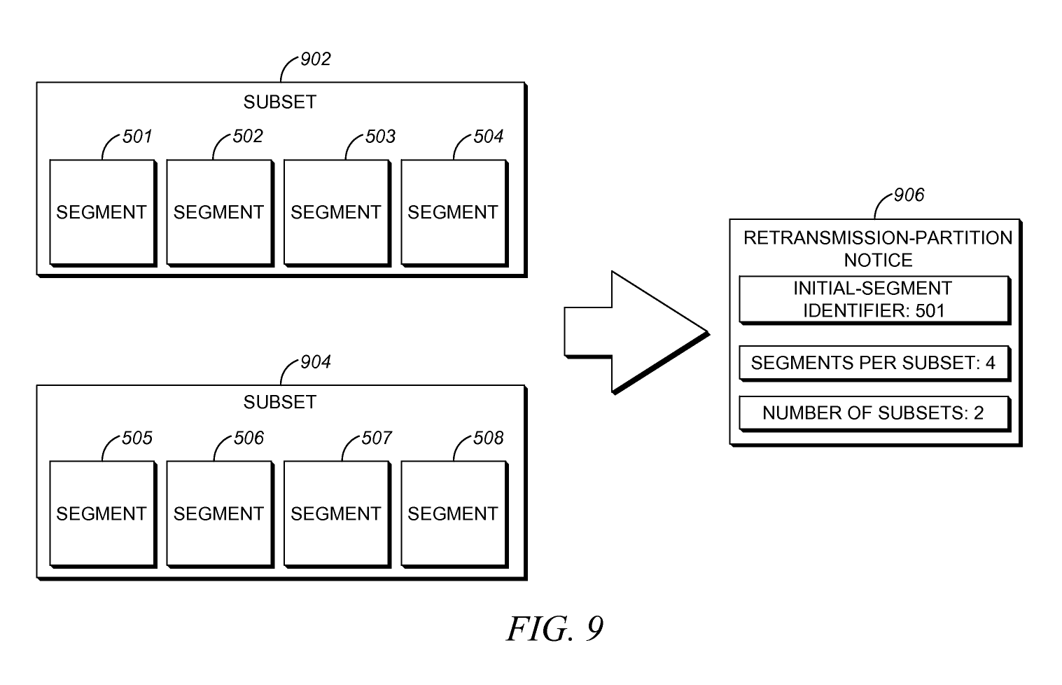

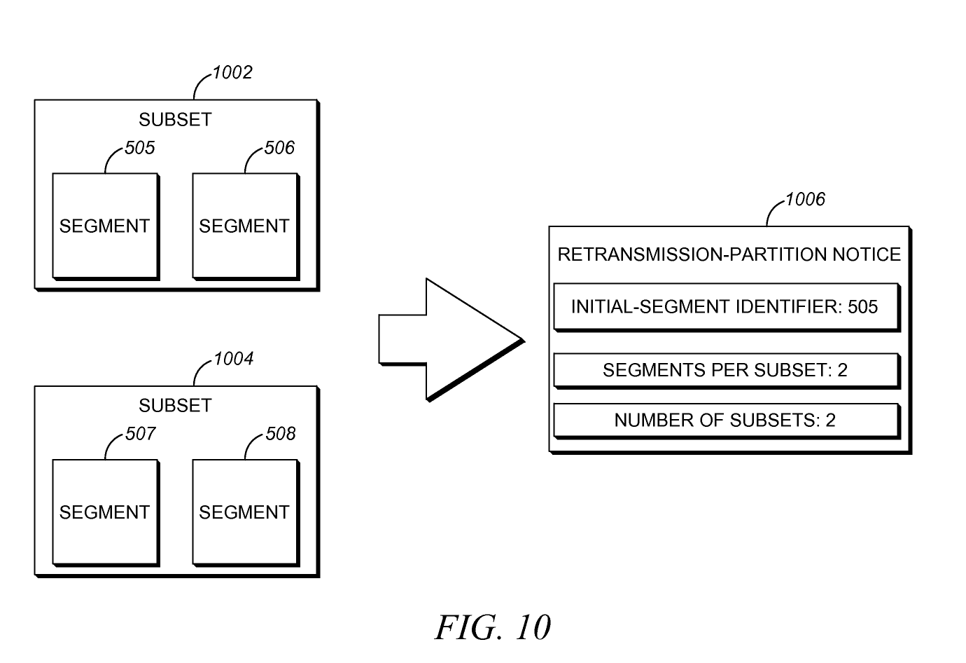

FIGS. 8-10 depict various aspects of example retransmission-partition notices and of example subsets of data-file segments identified by the respective example notices, in accordance with various embodiments. As shown in FIG. 8, an example retransmission-partition notice 800 includes a sequence identifier 802 of an initial data-file segment, a number 804 of sequential data-file segments per subset, and a number 806 of subsets. A first example retransmission-partition notice 906 of FIG. 9 identifies subsets 902 and 904 of data-file segments, and a second example retransmission-partition notice 1006 of FIG. 10 identifies subsets 1002 and 1004 of data-file segments. Those of skill in the art will appreciate that notices 800, 906, and/or 1006 may include different and/or additional data, and that subsets 902, 904, 1002, and/or 1004 may take other forms, without departing from the scope of the claims.

As depicted in FIGS. 9 and 10, the subsets identified by a respective notice may be mutually exclusive with respect to one another. As shown, subsets 902 and 904 are disjoint sets (and are thus mutually exclusive) in that the intersection of these two subsets is the empty set—in other words, they are disjoint because none of segments 501-508 are in both of subsets 902 and 904. Subsets 1002 and 1004 are similarly disjoint because none of segments 505-508 are in both of subsets 1002 and 1004.

The subsets identified by a respective notice may include data-file segments having sequential identifiers within respective subsets. For example, as shown in FIG. 9, none of the data-file segments in subset 902 have a respective identifier that is the same as that of any other segment in the subset. Subsets 904, 1002, and 1004 similarly include segments with sequential identifiers.

The subsets identified by a respective notice may collectively take the form of an ordered set such that any two subsets identified in the notice are comparable. FIGS. 9 and 10 depict embodiments where a first subset of data-file segments is less than a second subset of segments in that the respective identifier of each segment in the first subset is less than the respective identifiers of all of the segments in the second subset. As shown in FIG. 9, the identifier of segment 501 of subset 902 is less than the respective identifiers of all the segments in subset 904 (i.e., segments 505-508). Likewise, the respective identifier of each of segments 502-504 is less than the respective identifiers of segments 505-508. Therefore, in this embodiment, subset 902 is less than subset 904. Similarly, subset 1002 is less than subset 1004 because the respective identifier of each of segments 505 and 506 of subset 1002 is less than the respective identifiers of each of segments 507 and 508 of subset 1004.

A given notice may identify multiple subsets of data-file segments. For example, notice 906 identifies a first subset 902 and a second subset 904. Notice 1006 likewise identifies a first subset 1002 and a second subset 1004. As another possibility, a given notice may identify a single subset of data-file segments. The combination of distinct segments in the identified subsets may be a (coextensive or non-coextensive) subset of the already-broadcasted segments. For example, a given notice could identify a single subset of segments that includes all of the already-broadcasted segments.

In an embodiment, the subsets identified by a respective notice include subsets of an earlier-identified subset (i.e., a subset that had been identified by a previously-broadcasted notice). For example, subsets 1002 and 1004 identified by notice 1006 are subsets of the data-file segments of subset 904 identified by notice 906. The combination of segments in subset 1002 (that is, segments 505 and 506) and the segments in subset 1004 (i.e., segments 507 and 508) is coextensive with subset 904 (that includes segments 505, 506, 507, and 508).

Regarding step 406, the uplink time periods may be any periods of time suitable for carrying out the embodiments described herein. For example, a respective time period may take the form of one, part of one, and/or more than one time slot, frame, multi frame, packet, etc., according to one or more protocols such as TETRA, LTE, GSM, CDMA2000, and/or Internet Protocol (IP), among other possibilities (though the time periods need not be based on any given communication standard). The uplink time periods may be associated with respective subsets based on a time period during which a respective retransmission-partition notice is broadcasted. In an embodiment, each subset is associated with a respective successive time period following the time period during which the notice is broadcast. For example, if base station 202 broadcasts notice 906 during time period t=100, then subset 902 would be associated with time period t=101 and subset 904 would be associated with time period t=102. If notice 1006 were broadcast during time period t=103, then subsets 1002 and 1004 would be associated with time periods t=104 and t=105, respectively. If a given notice spans more than one time period, then each subset may be associated with respective successive time periods following the last time period during which the notice is broadcast. Other variations are possible as well.

After broadcasting a given retransmission-partition notice, the base station may broadcast one or more additional retransmission-partition notices so as to narrow the number of data-file segments to be rebroadcast. For example, the base station might broadcast notice 906 associating subsets 902 and 904 with time periods t=101 and t=102, respectively. If base station 202 were to receive a retransmission request during time period t=102, then the base station could responsively broadcast notice 1006 identifying subsets 1002 and 1004. Thus, in various embodiments, the wasting of air-interface resources is avoided by not rebroadcasting data-file segments (or further retransmission-partition notices pertaining thereto) for which no retransmission request was received (e.g., data-file segments 501-504 that are part of subset 902).

The base station may select the number of subsets of broadcasted data-file segments based on, for example, a number of unique data-file segments for which at least one retransmission request was received and/or a number of retransmission requests received with respect to at least one subset identified by a previously-broadcasted notice, among other possibilities. In an embodiment, the base station selects the number of subsets of broadcasted data-file segments based on a number of unique data-file segments already broadcast. For example, if all of data-file segments 501-508 have already been broadcast, then base station 202 may select a relatively greater number of subsets each having relatively fewer data-file segments, thus allowing for relatively more granular identification of data-file segments during a (possibly) more error-prone initial broadcasting of segments. Those of skill in the art will appreciate that other bases for selecting the number of subsets are possible as well.

Regarding step 408, the associated uplink time periods may be monitored for levels of received signal energy that exceed an uplink-request threshold. Collisions are possible if multiple WCDs attempt to send a communication during a given associated uplink time. However, in various embodiments, information such as the identity of the requesting WCD is unnecessary for identifying a need to rebroadcast a given data-file segment, because the data-file segments are broadcast (and rebroadcast) to all WCDs on a given channel, not just to the requesting WCD. Accordingly, an event such as the received signal energy (during a given uplink time period) exceeding the corresponding threshold can be presumed to be a retransmission request (i.e., one or more retransmission requests) regardless of the content (or identification of a sender) of a given communication during that uplink time period.

Regarding step 410, in an embodiment, at least one retransmission-partition notice is broadcast before at least one other data-file segment is initially broadcast. For example, after initially broadcasting data-file segments 501-504, the base station may broadcast a retransmission-partition notice identifying one or more subsets of those already-broadcasted segments. In an embodiment, at least one data-file segment is rebroadcast before at least one other data-file segment is initially broadcast. For example, after broadcasting the retransmission-partition notice identifying one or more subsets of data-file segments 501-504, base station 202 may initially broadcast data-file segment 505 while also monitoring the associated uplink time periods for retransmission requests. After initially broadcasting segment 505, but before initially broadcasting any of segments 506-508, the base station may rebroadcast any one or more of segments 501-504 for which a retransmission request was received. And certainly other examples could be listed.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
obtaining data-file segments that collectively make up a data file;
broadcasting the data-file segments on a downlink of a group data channel;
broadcasting retransmission-partition notices of broadcasted data-file segments, each notice associating subsets of the broadcasted data-file segments with respective uplink time periods;
monitoring the associated uplink time periods for retransmission requests; and
rebroadcasting the data-file segments of the subsets that correspond to any monitored time periods during which at least one retransmission request was received.

2. The method of claim 1, wherein the data file comprises at least one of an image file, a video file, an audio file, and a text file.

3. The method of claim 1, wherein obtaining the data-file segments comprises segmenting the data file into the obtained data-file segments.

4. The method of claim 1, wherein obtaining the data-file segments comprises receiving the data-file segments from a network entity.

5. The method of claim 1, wherein all of the data-file segments comprise the same data-file identifier.

6. The method of claim 1, wherein the data-file segments comprise sequence identifiers that sequentially identify respective segments with respect to other segments of the data file.

7. The method of claim 6, wherein broadcasting or rebroadcasting a given data-file segment comprises addressing the given data-file segment using its associated sequence identifier.

8. The method of claim 1, wherein the data-file segments are broadcasted using a short messaging service.

9. The method of claim 1, wherein the subsets identified by a respective notice comprise subsets of one subset identified by a previously-broadcasted notice.

10. The method of claim 1, wherein the subsets identified by a respective notice comprise subsets of data-file segments having sequential identifiers within respective subsets.

11. The method of claim 1, wherein the subsets identified by a respective notice are mutually exclusive with respect to one another.

12. The method of claim 11, wherein the subsets identified by a respective notice further comprise subsets of data-file segments having sequential identifiers within respective subsets.

13. The method of claim 11, wherein at least one of the notices comprises a sequence identifier of an initial data-file segment, a number of sequential data-file segments per subset, and a number of subsets.

14. The method of claim 1, wherein at least one of the notices comprises a sequence identifier of an initial data-file segment, a number of sequential data-file segments per subset, and a number of subsets.

15. The method of claim 1, further comprising selecting a number of subsets of broadcasted data-file segments based on a number of unique data-file segments already broadcast.

16. The method of claim 1, further comprising selecting a number of subsets of broadcasted data-file segments based on a number of retransmission requests received with respect to at least one subset identified by a previously-broadcasted notice.

17. The method of claim 1, further comprising selecting a number of subsets of broadcasted data-file segments based on a number of unique data-file segments for which at least one retransmission request was received.

18. The method of claim 1, wherein monitoring the associated uplink time periods for retransmission requests comprises monitoring the associated uplink time periods for levels of received signal energy that exceed an uplink-request threshold.

19. The method of claim 1, wherein at least one data-file segment is rebroadcast before at least one other data-file segment is initially broadcast.

20. A system comprising:
a communication interface comprising a wireless-communication interface;
a processor; and
data storage containing instructions executable by the processor for causing the system to carry out a set of functions, the set of functions comprising:
obtaining data-file segments that collectively make up a data file;
broadcasting the data-file segments on a downlink of a group data channel;
broadcasting retransmission-partition notices of broadcasted data-file segments, each notice associating subsets of the broadcasted data-file segments with respective uplink time periods;
monitoring the associated uplink time periods for retransmission requests; and
rebroadcasting the data-file segments of the subsets that correspond to any monitored time periods during which at least one retransmission request was received.
